(19) United States
(12) Patent Application Publication
(10) Pub. No.: US 2026/0044915 A1
(43) Pub. Date: Feb. 12, 2026

(54) DEVICE AND METHOD FOR LECTURE ANALYSIS USING NEURAL NETWORK

(71) Applicant: Firsthabit Co.,Ltd., Seoul (KR)

(72) Inventor: Jung Woo KANG, Seoul (KR)

(73) Assignee: Firsthabit Co.,Ltd., Seoul (KR)

(21) Appl. No.: 19/293,791

(22) Filed: Aug. 7, 2025

(30) Foreign Application Priority Data
Aug. 12, 2024 (KR) 10-2024-0107534

(51) Int. Cl. G06Q 50/20; G10L 25/51

(52) U.S. Cl. CPC G06Q 50/20; G10L 25/51

(57) ABSTRACT

A device and method for lecture analysis using neural networks are provided. The lecture analysis device comprises a data collection module configured to receive lecture data including lecture content in an online lecture; an analysis module configured to generate analysis data including at least one of summarized data for the online lecture and teacher analysis data related to a teacher who conducted the online lecture, based on the received lecture data; and an output module configured to output the analysis data as output data. The analysis module generates the analysis data from data using a pre-trained neural network applied to the lecture data.

### CROSS-REFERENCE TO RELATED APPLICATION

This application claims priority under 35 U.S.C. §119 to Korean Patent Application No. 10-2024-0107534 filed on Aug. 12, 2024, in the Korean Intellectual Property Office, the entire contents of which are hereby incorporated by reference.

### BACKGROUND

### Technical Field

The disclosure relates to a device and a method for lecture analysis using artificial intelligence (AI) technology including a neural network.

More particularly, the disclosure relates to a device and a method for lecture analysis that can analyze and provide features related to the teacher who conducted an online lecture along with summarized data on the corresponding online lecture by analyzing the online lecture using AI technology.

### Description of the Related Art

The contents set forth in this section merely provide background information on the present embodiments and do not constitute prior art.

In the case of online lecture sites that provide online lectures, the profile, history, curriculum, and the like of teachers who will conduct online lectures are posted on the sites to recruit students.

Generally, when respective students want to take online classes from the type of teachers they want, they will get a sense of the teaching style of each teacher through the introductions, promotional phrases, preview videos, and the like of each teacher uploaded to the site.

However, in many cases, online lecture sites, introductions written by teachers themselves, or the like do not properly reflect the features of actual lectures, and accordingly, it is not easy for students to discover teachers who meet their needs.

Furthermore, traditional computing systems are poorly suited to extract nuanced instructional or behavioral information (e.g., such as speaking tone, topic delivery methods, and entertainment value) from unstructured multimedia content such as online lectures. Existing video or audio analysis systems are typically limited to low-level metadata extraction (e.g., keyword indexing, image recognition) or require manual tagging, and cannot reliably interpret complex educational attributes like speaking style, content sequencing, or audience engagement. This results in a lack of objective, automated tools for evaluating or summarizing instructor performance at scale. Accordingly, there is a need for a technical solution that enables computing systems to analyze lecture content and derive human-interpretable insights—without relying on human tagging or manual intervention.

Therefore, there exists a sufficient need to clearly know the features of each teacher's teaching style or the like through an objective third-party analysis of actual online lectures of various teachers.

### BRIEF SUMMARY

As noted above, conventional computing systems and online platforms lack the technical capacity to extract nuanced behavioral and instructional attributes from unstructured lecture content. These systems are limited to basic keyword extraction or speech-to-text transcription and cannot autonomously assess pedagogical style, topic delivery structure, or interactive engagement from audiovisual data. Accordingly, there exists a need for a technological solution that enhances the automated understanding and classification of multimedia educational content (e.g., online lectures).

The disclosed subject matter provides a technical solution to the problem of automatically extracting meaningful instructional and behavioral characteristics from unstructured data obtained from online lectures. A system is described in which a set of pre-trained neural networks operates in a modular architecture to analyze various aspects of a lecture. These include generating a summary of the lecture content, identifying features related to the instructor's communication and delivery style, and evaluating engagement based on detected entertainment elements. Each analysis task is performed by a separate feature extraction unit, allowing the system to produce objective and interpretable data related to teaching quality, without relying on manual tagging or subjective evaluation.

The system processes input data that may include audio, video, and optional textual materials. The conversational analysis component evaluates parameters such as tone, vocabulary, pronunciation accuracy, and use of formal language. The instructional analysis component identifies presentation styles such as narrative explanation, use of examples, or visual support materials, and further evaluates the sequence in which topics are delivered. The engagement analysis component detects indicators such as laughter or vocal reactions from students to determine responsiveness to the instructor's delivery. These components are trained on domain-specific data and are capable of performing their respective analyses independently or in combination, enabling flexible deployment and improved system performance.

A further aspect includes a comparison between raw lecture data and a machine-generated summary in order to evaluate how closely an instructor's delivery adheres to a logical or standardized sequence. By analyzing topic sequencing through this comparison, the system provides insights into instructional structure that cannot be determined through conventional media analysis techniques. Collectively, the described subject matter improves the ability of computer systems to process, interpret, and classify complex educational content in a manner that enhances functionality in the fields of automated media analysis and personalized content delivery.

Various embodiments of the present disclosure provide a device and a method for lecture analysis that can analyze and provide features related to the teacher who conducted an online lecture along with summarized data on the corresponding online lecture by analyzing the online lecture using AI technology.

Specifically, the disclosed system addresses the technical challenge of extracting structured instructional metadata from unstructured video and audio sources by implementing multiple pre-trained neural networks configured to analyze different dimensions of a teacher's delivery and engagement. This includes summarizing lecture content, identifying delivery structure, and analyzing behavioral elements such as tone, vocabulary, and entertainment. Unlike prior systems that rely on manually labeled data or basic speech recognition, the present system offers a technical improvement by enabling end-to-end analysis through trained feature extraction units.

The technical benefits of the present disclosure are not limited to those mentioned above, and other advantages of the present disclosure that have not been mentioned can be understood by the following description and will be more clearly understood by the embodiments of the present disclosure. Furthermore, it will be readily appreciated that the objects and advantages of the present disclosure can be realized by the means set forth in the claims and combinations thereof.

According to some aspects of the disclosure, a lecture analysis device comprises a data collection module configured to receive lecture data including lecture content in an online lecture; an analysis module configured to generate analysis data including at least one of summarized data for the online lecture and teacher analysis data related to a teacher who conducted the online lecture based on the received lecture data; and an output module configured to output the analysis data as output data, wherein the analysis module generates the analysis data from the lecture data based on a pre-trained neural network.

Additionally, the lecture data comprises video data obtained by capturing the online lecture and audio data for voices in the online lecture.

Additionally, the analysis module comprises a lecture summarization unit configured to generate the summarized data by summarizing the lecture content based on the lecture data; and a teacher analysis unit configured to generate the teacher analysis data by analyzing features of a teacher who conducts the online lecture based on the lecture data.

Additionally, the teacher analysis unit comprises a conversational feature extraction unit configured to extract conversational features related to a voice of the teacher based on the lecture data; a description feature extraction unit configured to extract description features related to a delivery method of the lecture content of the teacher based on the lecture data; and an entertainment feature extraction unit configured to extract entertainment features related to a level of entertainment of the teacher based on the lecture data.

Additionally, the conversational feature extraction unit extracts at least one of speaking mannerism information related to a speaking mannerism of the teacher, vocabulary information related to vocabulary related to words used by the teacher, standard language information related to whether the teacher speaks a standard language, and pronunciation information related to pronunciation accuracy of the teacher, as the conversational features.

Additionally, the description feature extraction unit extracts at least one of description method information and description sequence information of the teacher as the description features.

Additionally, the description feature extraction unit extracts at least one of a storytelling method, an exemplification method, and a visual materialization method as the description method information.

Additionally, the description feature extraction unit receives the summarized data from the lecture summarization unit, compares the summarized data with the lecture data, and based on a comparison result, extracts a sequence of mention for each of a plurality of topics included in the lecture content as the description sequence information.

Additionally, the entertainment feature extraction unit extracts at least one of joke information related to a level of jokes in the online lecture by the teacher and reaction information related to reactions by students to the jokes as the entertainment features.

Additionally, the lecture analysis device further comprises a training module configured to train the conversational feature extraction unit, the description feature extraction unit, and the entertainment feature extraction unit included in the teacher analysis unit, and the lecture summarization unit.

Unlike conventional monolithic AI pipelines, the system described herein improves computing efficiency and scalability by dividing the analysis workload across independently trainable neural modules. This modular architecture allows for faster inference, easier updates, and more precise tuning for specific features such as vocal tone, instructional method, and audience response—advancing the state of the art in AI-driven video content analysis.

The device and the method for lecture analysis according to some embodiments of the present disclosure have a novel effect of being able to analyze and provide features related to the teacher who conducted an online lecture along with summarized data on the corresponding online lecture by analyzing the online lecture using AI technology. That is, in many cases, online lecture sites, introductions written by teachers themselves, or the like do not properly reflect the features of actual lectures, but the device and the method for lecture analysis according to some embodiments of the present disclosure enables objective analysis of the teaching styles and the like of various teachers by analyzing the features of the teachers using AI technology for actual online lectures of various teachers.

In addition, the device and the method for lecture analysis according to some embodiments of the present disclosure have a novel effect of enabling multifaceted analysis of the teaching style of a teacher by separating and analyzing conversational features (e.g., speaking mannerism, vocabulary, use of standard language, pronunciation accuracy, etc.), description features (e.g., description method information, description sequence information, etc.), and other entertainment features related to the entertainment in the class of the teacher when analyzing the features of the teacher.

These features collectively enable the system to perform technically complex educational content analysis across audio, video, and textual domains, providing a computing-based solution for tasks that have traditionally required human evaluation.

In other words, the system improves the operation of a computing device by enabling the extraction of human-interpretable pedagogical features from multimedia data, which conventional computing systems cannot perform without manual annotation.

In addition to the foregoing description, specific effects of the present disclosure will be described together while describing specific details for practicing the present disclosure below.

### BRIEF DESCRIPTION OF THE SEVERAL VIEWS OF THE DRAWINGS

FIG. 1 shows a lecture analysis system according to some embodiments of the present disclosure.

FIG. 2 is a block diagram of the lecture analysis device according to some embodiments of the present disclosure.

FIG. 3 shows one example of the lecture data according to some embodiments of the present disclosure.

FIG. 4 is a diagram for describing the structure of the neural network according to some embodiments of the present disclosure.

FIG. 5 is a block diagram of the analysis module according to some embodiments of the present disclosure.

FIG. 6 is a detailed block diagram of a teacher analysis unit included in the analysis module according to some embodiments of the present disclosure.

FIGS. 7a to 7c are diagrams for describing a learning phase and an inferencing phase of each feature extraction unit included in the teacher analysis unit according to some embodiments of the present disclosure.

FIG. 8 is a flowchart of a lecture analysis method according to some embodiments of the present disclosure.

FIG. 9 is a diagram for describing a hardware implementation of a lecture analysis device that performs a lecture analysis method according to some embodiments of the present disclosure.

### DETAILED DESCRIPTION

The terms or words used in the disclosure and the claims should not be construed as limited to their ordinary or lexical meanings. They should be construed as the meaning and concept in line with the technical idea of the disclosure based on the principle that the inventor can define the concept of terms or words in order to describe his/her own inventive concept in the best possible way. Further, since the embodiment described herein and the configurations illustrated in the drawings are merely one embodiment in which the disclosure is realized and do not represent all the technical ideas of the disclosure, it should be understood that there may be various equivalents, variations, and applicable examples that can replace them at the time of filing this application.

Although terms such as first, second, A, B, etc., used in the description and the claims may be used to describe various components, the components should not be limited by these terms. These terms are only used to differentiate one component from another. For example, a first component may be referred to as a second component, and similarly, a second component may be referred to as a first component, without departing from the scope of the disclosure. The term ‘and/or’ includes a combination of a plurality of related listed items or any item of the plurality of related listed items.

The terms used in the description and the claims are merely used to describe particular embodiments and are not intended to limit the disclosure. Singular forms are intended to include plural forms unless the context clearly indicates otherwise. In the application, terms such as “comprise,” “comprise,” “have,” etc., should be understood as not precluding the possibility of existence or addition of features, numbers, steps, operations, components, parts, or combinations thereof described herein.

Unless otherwise defined, the phrases “A, B, or C,” “at least one of A, B, or C,” or “at least one of A, B, and C” may refer to only A, only B, only C, both A and B, both A and C, both B and C, all of A, B, and C, or any combination thereof.

Unless being defined otherwise, all terms used herein, including technical or scientific terms, have the same meaning as commonly understood by those skilled in the art to which the disclosure pertains.

Terms such as those defined in commonly used dictionaries should be construed as having a meaning consistent with the meaning in the context of the relevant art, and are not to be construed in an ideal or excessively formal sense unless explicitly defined in the application. In addition, each configuration, procedure, process, method, or the like included in each embodiment of the disclosure may be shared to the extent that they are not technically contradictory to each other.

The present disclosure addresses a computer-centric technical problem: how to enable a computing system to extract pedagogically meaningful insights from lecture video and audio streams. A specific technical solution is provided by implementing a neural network architecture composed of independently trained modules. Each module is configured to extract features such as voice tone, vocabulary usage, teaching method, or student engagement patterns. These modules operate in concert to produce a high-level teacher profile and lecture summary. By structuring the system in this manner, the computing device is improved in its ability to process unstructured and noisy multimedia data, including real-time or archived lecture content.

Hereinafter, a device and a method for lecture analysis and a lecture analysis system including the same according to some embodiments of the present disclosure will be described with reference to FIGS. 1 to 9.

FIG. 1 shows a lecture analysis system according to some embodiments of the present disclosure.

Referring to FIG. 1, a lecture analysis system 1 may include a lecture database 100, a lecture analysis device 200, and a communication network 300.

The lecture database 100 may be a database that stores, manages, transmits, and outputs a plurality of online lectures.

As one example, the lecture database 100 may provide online lectures to a web or app managed by an online lecture site, and a user terminal or the like linked to the lecture database 100 may access the corresponding web or app and take online lectures. In this case, a user corresponding to the user terminal may refer to a student who is taking or intends to take an online lecture.

As another example, the lecture database 100 may transmit online lectures to the lecture analysis device 200. In other words, the lecture database 100 may provide lecture data related to online lectures to the lecture analysis device 200 in order for the lecture analysis device 200 to perform lecture analysis on each of a plurality of online lectures.

In this case, the lecture data may include lecture content in an online lecture. For example, the lecture data may include video data obtained by capturing an online lecture, audio data obtained by recording the teacher's voice in the online lecture, etc., but the embodiment of the present disclosure is not limited thereto, and the lecture data may also include text data or image data for textbooks, lecture materials, etc., used in conducting the corresponding online lecture.

Further, the lecture database 100 may be in the form of a workstation, a data center, an internet data center (IDC), a direct attached storage (DAS) system, a storage area network (SAN) system, a network attached storage (NAS) system, and a redundant array of inexpensive disks or a redundant array of independent disks (RAID) system, but the embodiment of the present disclosure is not limited thereto.

The lecture analysis device 200 may generate analysis data based on the lecture data received from the lecture database 100 and output the generated analysis data as output data.

As some examples, the lecture analysis device 200 may generate and output summarized data on an online lecture, teacher analysis data related to a teacher who conducted the online lecture, and the like, as the analysis data. In this case, the lecture analysis device 200 may separate and analyze conversational features (e.g., speaking mannerism, vocabulary, use of standard language, pronunciation accuracy, etc.), description features (e.g., description method information, description sequence information, etc.), and other entertainment features related to the entertainment in the class (e.g., the level of jokes shared in class and the degree of reaction thereto) of the teacher, as the teacher analysis data. A detailed description thereof will be given later.

When the output data based on the analysis data is generated, the lecture analysis device 200 may output the generated output data to the lecture database 100 and a user terminal or the like linked to the lecture analysis device 200. In this case, the user corresponding to the user terminal may refer to a student who is taking or intends to take the online lecture.

The communication network 300 refers to a communication means that performs data exchange between the lecture database 100 and the lecture analysis device 200.

In this case, the communication network 300 may include a network based on wired Internet technology, wireless Internet technology, and short-range communication technology. The wired Internet technology may include, for example, at least one of a local area network (LAN) and a wide area network (WAN). The wireless Internet technology may include, for example, at least one of wireless LAN (WLAN), Digital Living Network Alliance (DMNA), Wireless Broadband (WiBro), World Interoperability for Microwave Access (WiMAX), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), and 5G New Radio (NR) technology. However, the present embodiment is not limited thereto. The short-range communication technology may include, for example, at least one of Bluetooth, Radio Frequency Identification (RFID), Infrared Data Association (IrDA), Ultra-Wideband (UWB), ZigBee, Near Field Communication (NFC), Ultra Sound Communication (USC), Visible Light Communication (VLC), Wi-Fi, Wi-Fi Direct, and 5G New Radio (NR). However, the present embodiment is not limited thereto.

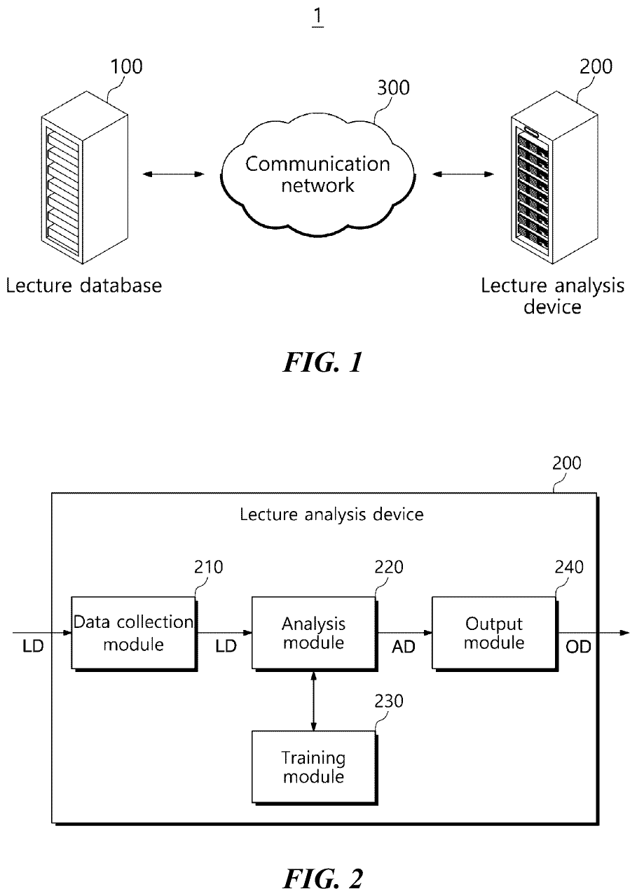

In the following, the structure and operation of the lecture analysis device 200 according to some embodiments of the present disclosure will be described in greater detail with reference to FIGS. 2 to 9.

FIG. 2 is a block diagram of the lecture analysis device according to some embodiments of the present disclosure.

Referring to FIGS. 1 and 2, the lecture analysis device 200 may include a data collection module 210, an analysis module 220, a training module 230, and an output module 240.

The data collection module 210 may receive lecture data (hereinafter referred to as “LD”) from the lecture database 100.

The lecture data LD may include lecture content in an online lecture. For example, the lecture data LD may include video data obtained by capturing an online lecture, audio data obtained by recording voices in the online lecture, etc., but the embodiment of the present disclosure is not limited thereto, and the lecture data LD may also include text data or image data for textbooks, lecture materials, etc., used in conducting the corresponding online lecture.

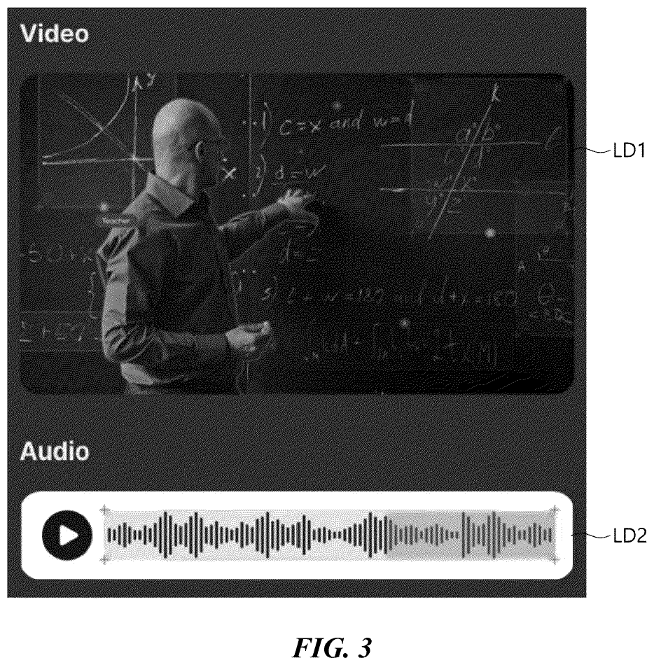

In the following, the lecture data LD according to some embodiments of the present disclosure will be described in detail with reference to FIG. 3.

FIG. 3 shows one example of the lecture data according to some embodiments of the present disclosure.

Referring to FIGS. 2 and 3, the lecture data LD according to some embodiments of the present disclosure may include video data LD1 obtained by capturing an online lecture and audio data LD2 obtained by recording voices in the online lecture.

The video data LD1 may be video data obtained by capturing the progress of a class of a teacher via a filming device at a place of the class, a filming studio, etc. In this case, the video data may include the teacher's body, handwriting made by the teacher, lecture materials printed for conducting the class, and the like as objects.

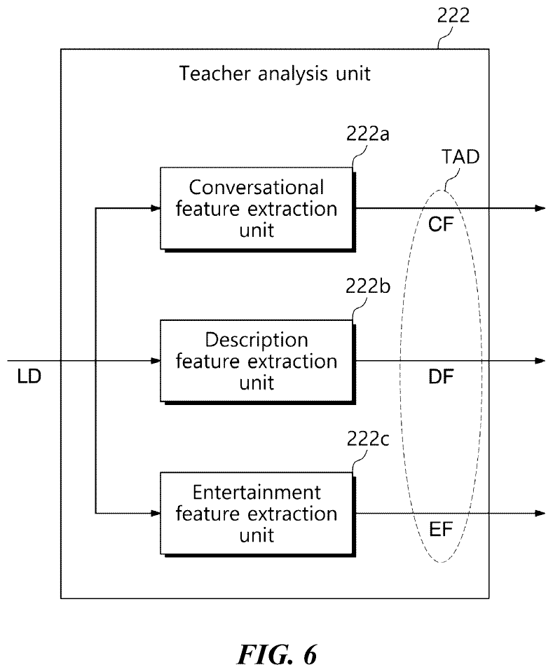

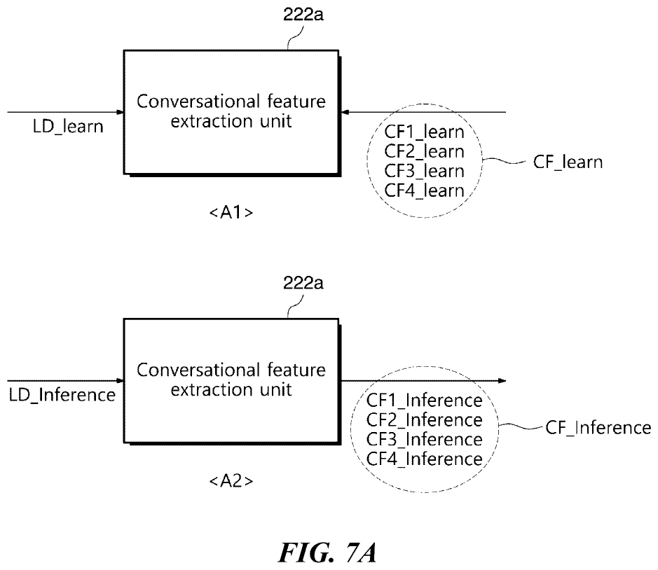

The audio data LD2 may be data including the voice of the teacher in the corresponding lecture received via the filming device at the place of the class, the filming studio, etc., or received via a separate audio sensor or the like other than the filming device. In this case, the audio data LD2 may include not only the voice of the corresponding teacher but also the voices of the students present at the corresponding place of the class or the filming studio, and these voices of the students may be used in the process of extracting entertainment features (EF in FIG. 6) by an entertainment feature extraction unit (222c in FIG. 6) described later.

Referring again to FIGS. 1 and 2, the data collection module 210 may transfer the lecture data LD to other components in the lecture analysis device 200. As one example, the data collection module 210 may transfer the lecture data LD to the analysis module 220, the training module 230, and the like, but the embodiment of the present disclosure is not limited thereto.

The analysis module 220 may generate analysis data (hereinafter referred to as “AD”) based on the lecture data LD. In this case, the analysis data AD may include summarized data, which is data obtained by summarizing the lecture content of the lecture data LD, and teacher analysis data obtained by analyzing the features of the teacher of the lecture data LD. A detailed description thereof will be given later.

Further, the analysis module 220 may generate the analysis data AD from the lecture data LD by using AI (artificial intelligence) technology. In this case, the analysis module 220 may generate the analysis data AD from the lecture data LD by using deep learning methods and structures. As one example, the analysis module 220 may generate the analysis data AD by using a pre-trained neural network structure.

In a more detailed description, a deep-learning technique, which is a kind of machine learning, goes down to a deep level and is subjected to learning in multiple stages based on data. In other words, deep learning refers to a set of machine learning algorithms that extract core data from a plurality of data while moving up the stages.

As some examples, the neural network may use a variety of known deep learning structures. For example, the neural network may use structures such as a convolutional neural network (CNN), a recurrent neural network (RNN), a deep belief network (DBN), or a graph neural network (GNN), a generative adversarial network (GAN), a transformer, and an auto-encoder.

Specifically, a CNN (convolutional neural network) is a model that simulates the function of the human brain, created based on the assumption that when a person recognizes an object, s/he extracts basic features of the object, then performs complex calculations in the brain, and based on the results, recognizes the object. The CNN may include, but is not limited to, known structures such as LeNet, AlexNet, VGGNet, GoogleNet, and ResNet.

An RNN (recurrent neural network) is widely used for natural language processing, etc., is a structure effective in processing time-series data that changes over time, and is capable of constructing an artificial neural network structure by stacking layers at every instant.

A DBN (deep belief network) is a deep learning structure constructed by stacking a restricted Boltzmann machine (RBM), which is a deep learning technique, in multiple layers. When a certain number of layers are obtained by repeating restricted Boltzmann machine (RBM) training, a DBN (deep belief network) having the corresponding number of layers can be constructed.

A GNN (graphic neural network; hereinafter, GNN) refers to an artificial neural network structure implemented in a way that derives a similarity and feature points between modeling data by using the modeling data modeled based on data mapped between particular parameters.

A GAN (generative adversarial network, hereinafter, GAN) refers to an artificial neural network structure that creates new data in a similar form to the input data by using a generative neural network and a discriminative neural network. The GAN may include the known DCGAN (deep convolutional GAN), CGAN (conditional GAN), WGAN (Wasserstein GAN), StyleGAN (style-based GAN), CycleGAN, etc., but the embodiment of the present disclosure is not limited thereto.

A transformer is an artificial neural network in an encoder-decoder structure that utilizes attention, and allows for identifying the overall meaning between an input sequence and an output sequence. Transformers allow all elements of an input sequence to affect an output sequence by using an attention mechanism, and through this, both the encoder and decoder can take the entire sequence into account. Transformers can use not only natural languages and time series data but also images as input by patching them.

An auto-encoder is a deep learning structure that performs the role of extracting and reconstructing the features of data. Representatively, an auto-encoder includes an encoder that compresses input values and a decoder that reconstructs the compressed data. The encoder converts input values into lower-dimensional latent representations, and the decoder reconstructs the latent representations in the same dimension as the input values. In this case, the encoder and decoder may each be composed of a multilayer perceptron (MLP). When training an auto-encoder, input data is input, and weights and biases are used in the training in a direction of minimizing the difference between the output value and the input value. The auto-encoder trained as such can extract the features of input data well and reconstruct noisy input data. Auto-encoders are utilized mainly in the fields of data compression, dimensionality reduction, noise removal, data generation, etc., and can also be utilized in the fields of image recognition, natural language processing, speech recognition, etc.

Further, the training of the artificial neural network of the neural network may be achieved by adjusting the weights of the connecting lines between nodes (and also adjusting the bias values if necessary) so that a desired output is obtained for a given input. In addition, the artificial neural network can continuously update the weight values by training. Moreover, methods such as backpropagation may be used for training the artificial neural network.

In this case, unsupervised learning, semi-supervised learning, supervised learning, and the like may be used as the machine learning method of the artificial neural network.

Furthermore, the neural network may be controlled to automatically update the artificial neural network structure for outputting analysis data after training according to settings.

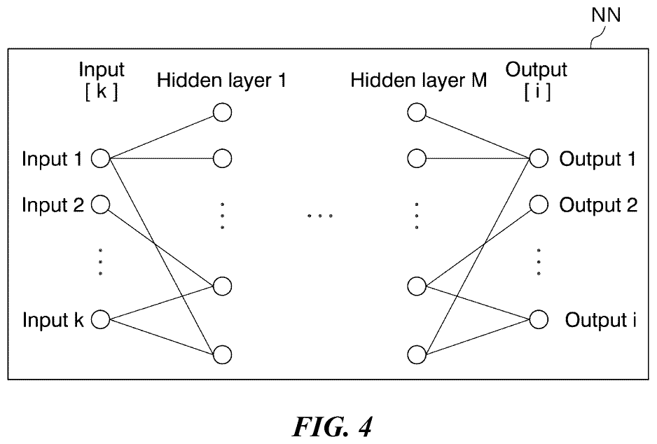

In the following, a neural network structure according to some embodiments of the present disclosure will be described with reference to FIG. 4.

FIG. 4 is a diagram for describing the structure of the neural network according to some embodiments of the present disclosure.

Referring to FIG. 4, the neural network (hereinafter referred to as “NN”) according to some embodiments of the present disclosure may include an input layer Input, an output layer Output, and M hidden layers arranged between the input layer and the output layer.

Here, weights may be set for the edges that connect the nodes in the respective layers. The presence or absence of such weights or edges may be added, removed, or updated during the training process. Therefore, the weights of the nodes and edges arranged between k input nodes and i output nodes may be updated through the training process.

Before the neural network NN performs training, all nodes and edges may be set to initial values. However, if information is input cumulatively, the weights of the nodes and edges may be changed, and in this process, matching may be made between the parameters input as training factors and the values assigned to output nodes.

Additionally, if a cloud server is utilized, the neural network NN may receive and process a large number of parameters. Therefore, the neural network NN may perform training based on an immense amount of data.

The weights of the nodes and edges between the input and output nodes constituting the neural network NN may be updated by the training process of the neural network NN.

Furthermore, the parameters input to or output from the neural network NN may be further expanded to various data.

Referring again to FIGS. 1 and 2, the analysis module 220 may be trained by the training module 230.

As some examples, the training module 230 may control the training of the analysis module 220 and the neural network included in the analysis module 220. In other words, the training module 230 may proceed with and control the training process of the analysis module 220 by using predefined training data.

In this case, the training module 230 may provide a control signal for controlling the training of the analysis module 220, labeling data used in the training process of the analysis module 220, etc., to the analysis module 220. The detailed training process of the analysis module 220 by the training module 230 will be described later.

The output module 240 may generate and output output data (hereinafter referred to as “OD”) based on the analysis data AD.

As one example, the analysis data AD may include summarized data and teacher analysis data as described below, where the teacher analysis data may include conversational features (e.g., speaking mannerism, vocabulary, use of standard language, pronunciation accuracy, etc.), description features (e.g., description method information, description sequence information, etc.), and other entertainment features related to the entertainment in the class (e.g., the level of jokes shared in class and the degree of reaction thereto) of the teacher who conducted the corresponding online lecture, and in this case, the output module 240 may generate and output a graphic object in which the summarized data, the conversational features, description features, and entertainment features of the teacher, etc., are visually comprehensively displayed as output data OD. In this case, the output data OD may be in the form of a text graphic object, an image graphic object, a video graphic object, etc.

Further, when the output data OD based on the analysis data AD is generated, the output module 240 may output the generated output data OD to the user terminal or the like linked to the lecture database 100 and the lecture analysis device 200. In this case, the user corresponding to the user terminal may refer to a student who is taking or intends to take the online lecture.

The subject matter described herein provides a technical improvement in natural language and multimedia processing by utilizing a modular neural architecture. Each component of the system is trained to process domain-specific data, such as lecture tone, instructional sequence, or student vocal responses. This separation of tasks allows each analysis unit to operate independently or in combination, improving inference accuracy and scalability. Additionally, this modular design supports optimization and retraining of specific features without requiring full reengineering of the overall system, which enhances computational efficiency during deployment and use.

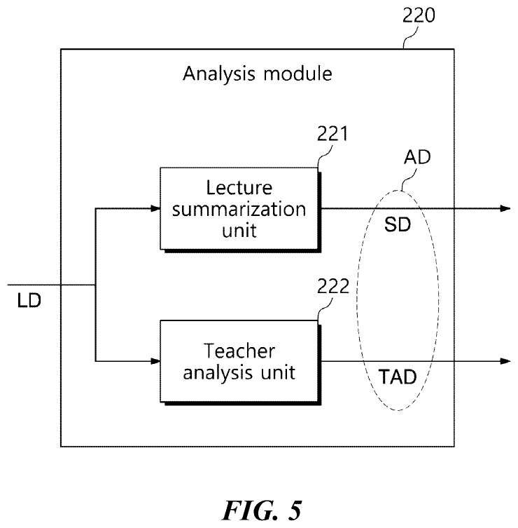

In the following, the operation of the analysis module 220 and the training process by the training module 230 according to some embodiments of the present disclosure will be described in greater detail with reference to FIGS. 5 to 7c.

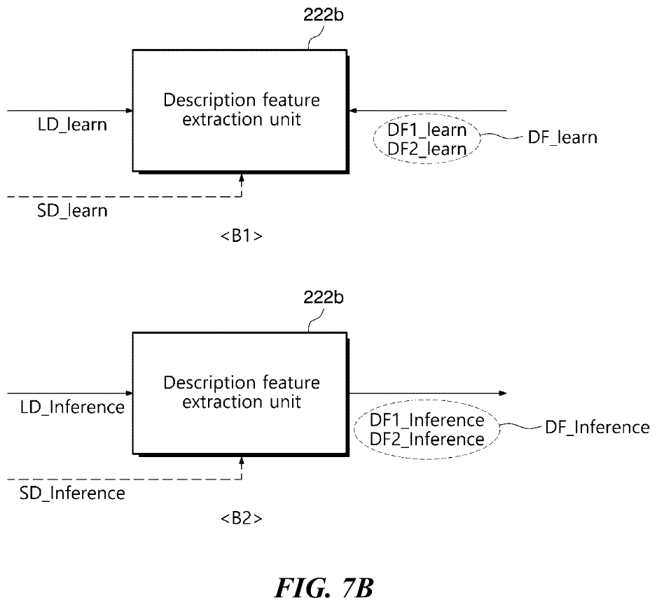

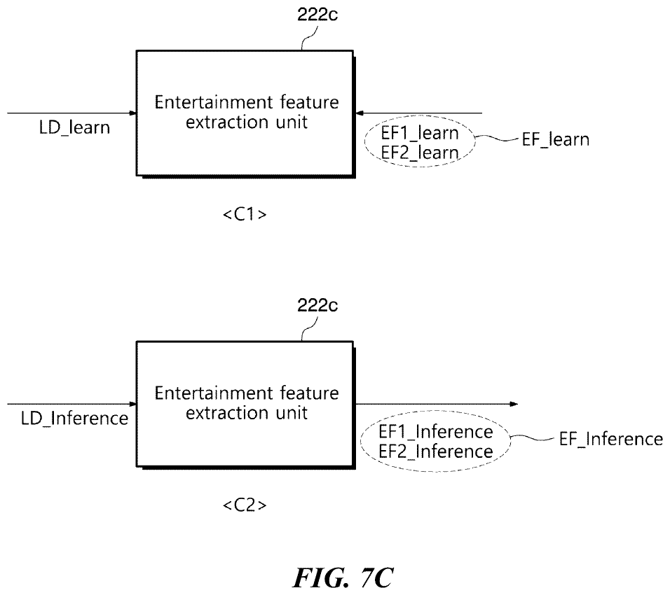

FIG. 5 is a block diagram of the analysis module according to some embodiments of the present disclosure. FIG. 6 is a detailed block diagram of a teacher analysis unit included in the analysis module according to some embodiments of the present disclosure. FIGS. 7a to 7c are diagrams for describing a learning phase and an inferencing phase of each feature extraction unit included in the teacher analysis unit according to some embodiments of the present disclosure.

Referring to FIGS. 2, 3, and 5, the analysis module 220 according to some embodiments of the present disclosure may generate the analysis data AD based on the lecture data LD, and may specifically include a lecture summarization unit 221 and a teacher analysis unit 222.

The lecture summarization unit 221 may generate summarized data (hereinafter referred to as “SD”) based on the lecture data LD. The summarized data SD may be data obtained by summarizing the lecture content in the lecture data LD.

As some examples, the lecture summarization unit 221 may generate the summarized data SD by inputting the lecture data LD into a pre-trained summarization model. In this case, the summarization model may be a model based on a transformer structure out of the types of neural networks. As one example, the summarization model may include a generative neural network model (e.g., ChatGPT) or a modified model thereof, but the embodiment of the present disclosure is not limited thereto. In this case, the summarization model may be pre-trained to generate the summarized data SD by extracting the main contents from the lecture data LD when the corresponding lecture data LD is input.

The teacher analysis unit 222 may generate teacher analysis data (hereinafter referred to as “TAD”) based on the lecture data LD. The teacher analysis data TAD may be data obtained by analyzing the features of the teacher in the lecture data LD. In this case, the lecture data LD may include the video data LD1 and the audio data LD2 as described above.

More particularly, referring to FIGS. 2, 3, 5, and 6, the teacher analysis unit 222 according to some embodiments of the present disclosure may generate the teacher analysis data TAD based on the lecture data LD, and may specifically include a conversational feature extraction unit 222a, a description feature extraction unit 222b, and an entertainment feature extraction unit 222c.

The conversational feature extraction unit 222a may extract the conversational features (hereinafter referred to as “CF”) of the teacher in the corresponding online lecture based on the lecture data LD. In this case, the conversational features CF may refer to features related to the voice uttered by the teacher in the corresponding online lecture. In this case, the conversational feature extraction unit 222a may extract the conversational features CF based on the audio data LD2 included in the lecture data LD.

As one example, the conversational features CF may include speaking mannerism of the teacher, vocabulary related to the words used by the teacher, whether the teacher uses a standard language, the pronunciation accuracy of the teacher, and the like. In other words, the conversational feature extraction unit 222a may extract at least one of speaking mannerism information of the teacher, vocabulary information related to vocabulary related to the words used by the teacher, standard language information related to whether the teacher uses a standard language, and pronunciation information related to the pronunciation accuracy of the teacher, as the conversational features CF.

The speaking mannerism information refers to the overall speaking style of the teacher when speaking in the online lecture. As one example, the speaking mannerism information may include the voice tone, speaking speed, presence or absence and degree of emotional expressions, etc., of the teacher. In this case, the speaking mannerism information may be categorized into a calm type, a soft type, an energetic type, a passionate type, etc.

The vocabulary information refers to the range and types of words used by the teacher. As one example, the vocabulary information encompasses the inclusion and degree of everyday words or specialized terms related to particular fields, etc. In this case, the vocabulary information may be categorized into an everyday vocabulary type, an intermediate vocabulary type, a specialized vocabulary type, etc.

The standard language information refers to data related to whether the teacher uses a standard language. In this case, the standard language information may be categorized into a standard type, an intermediate type, a non-standard type (dialect type), etc.

The pronunciation information may refer to data related to the pronunciation accuracy of the teacher. As one example, the conversational feature extraction unit 222a may extract the pronunciation information based on the clarity, level of clarity (e.g., noise ratio, SNR (signal-to-noise ratio), etc.), and the like in the interpretation of the audio data LD2 of the teacher. In this case, the pronunciation information may be categorized into an excellent type, an intermediate type, a poor type, etc.

In the following, the learning phase and inferencing phase of the conversational feature extraction unit 222a according to some embodiments of the present disclosure will be described with further reference to FIG. 7a. Here, <A1> of FIG. 7a shows the learning phase of the conversational feature extraction unit 222a, and <A2> of FIG. 7a shows the inferencing phase of the conversational feature extraction unit 222a.

Referring to FIGS. 2, 5, and 6, and <A1> of FIG. 7a, the conversational feature extraction unit 222a may be pre-trained by the training module 230 to output learning conversational features CF_learn based on learning lecture data LD_learn when the learning lecture data LD_learn is input. That is, the conversational feature extraction unit 222a may use the learning lecture data LD_learn and the learning conversational features CF_learn as a training data set in the learning phase.

The learning conversational features CF_learn may include learning speaking mannerism information CF1_learn, learning vocabulary information CF2_learn, learning standard language information CF3_learn, and learning pronunciation information CF4_learn.

These learning conversational features CF_learn may be data input by a manager of the lecture analysis device 200. In other words, the learning conversational features CF_learn may be data input by the manager of the lecture analysis device 200 so as to match the lecture data LD_learn as learning data. In this case, the learning speaking mannerism information CF1_learn, learning vocabulary information CF2_learn, learning standard language information CF3_learn, and learning pronunciation information CF4_learn may be input to the conversational feature extraction unit 222a as the results of the respective category classification (e.g., in the case of the learning speaking mannerism information CF1_learn, one of the calm type, soft type, energetic type, and passionate type), as described above.

In this case, the learning conversational features CF_learn may be used as correct answer data, i.e., labeling data. In other words, in the learning phase of the conversational feature extraction unit 222a, the learning speaking mannerism information CF1_learn, learning vocabulary information CF2_learn, learning standard language information CF3_learn, and learning pronunciation information CF4_learn input by the manager of the lecture analysis device 200 may be used as labeling data.

That is, the conversational feature extraction unit 222a may be trained in a supervised learning manner in which the learning lecture data LD_learn is input to the input terminal and the learning conversational features CF_learn are applied to the output terminal. However, this is merely one example and the present disclosure is not limited thereto.

Referring to FIGS. 2, 5, and 6, and <A2> of FIG. 7a, when lecture data LD_inference is input as input data in the inferencing phase, the conversational feature extraction unit 222a may output conversational features CF_inference corresponding to the lecture data LD_inference. In this case, the conversational features CF_inference may include speaking mannerism information CF1_inference, vocabulary information CF2_inference, standard language information CF3_inference, and pronunciation information CF4_inference, as described above.

The description feature extraction unit 222b may extract the description features (hereinafter referred to as “DF”) of the teacher in the corresponding online lecture based on the lecture data LD. In this case, the description features DF may refer to features related to the way the teacher delivers the lecture content while conducting the corresponding online lecture. In this case, the description feature extraction unit 222b may extract the description features DF based on the video data LD1 and the audio data LD2 included in the lecture data LD.

As one example, the description features DF may include the description method information, the description sequence information, etc., of the teacher. In other words, the description feature extraction unit 222b may extract at least one of the description method information and description sequence information of the teacher as the description features DF.

The description method information may include a storytelling method, an exemplification method, a visual materialization method, etc. In other words, the description method information may be categorized into the storytelling method, the exemplification method, the visual materialization method, etc. The storytelling method refers to a method of describing the background, main characters, development of events, and the like of a particular fact (e.g., a historical event) in a narrative format when the teacher conveys the corresponding fact, the exemplification method refers to a method of describing a particular topic or concept or the like by applying it to an everyday situation or the like when the teacher describes it, and the visual materialization method refers to a method of presenting audiovisual materials such as animations and videos rather than just describing in voice when the teacher describes a particular concept. In this case, the description feature extraction unit 222b may determine the description method information for the teacher as the storytelling method, exemplification method, visual materialization method, or the like by analyzing the video data LD1 and the audio data LD2 included in the lecture data LD (e.g., determining whether the video data LD1 includes visual materials, etc.).

The description sequence information may be information on which topic the teacher mentioned and described first out of a plurality of topics included in the lecture content of the corresponding online lecture. In other words, the description sequence information may refer to the sequence of mention for each of the plurality of topics included in the lecture content. In this case, the description sequence information may be categorized into a standardized method that follows the sequence of each unit pre-classified in a textbook, an unstandardized method that does not follow the sequence of each unit pre-classified in the textbook, etc.

In this case, the description feature extraction unit 222b may compare the lecture data LD with the summarized data SD generated by the lecture summarization unit 221, and determine the description sequence information based on the comparison result. As one example, the description feature extraction unit 222b may determine the appearance position or appearance point of a topic (description topic) in each of the lecture data LD and the summarized data SD, and determine the description sequence information based on the determined appearance position or appearance point. For example, the description feature extraction unit 222b may determine the description sequence information of the corresponding teacher as the “standardized method” if the appearance positions of each topic in the lecture data LD and the summarized data SD match or are similar within a predefined threshold range, and may determine the description sequence information of the corresponding teacher as the “unstandardized method” if the appearance positions of each topic in the lecture data LD and the summarized data SD differ by the corresponding threshold range or greater. That is, the summarized data SD is data obtained by summarizing the entire data included in the lecture data LD, and thus includes the results obtained by excerpting and re-writing some data from the entire lecture data LD without being bound by the description sequence information of the teacher. Therefore, the summarized data SD is data written according to a general logical concept unrelated to the description sequence information of the teacher, e.g., the sequence of each unit pre-classified in the textbook and the like. Accordingly, the description feature extraction unit 222b may determine the description sequence information of the teacher in the corresponding lecture data LD as the standardized method if the description sequence information in the summarized data SD and the lecture data LD is similar, and on the contrary, may determine the description sequence information of the teacher as the unstandardized method if they are dissimilar.

In the following, the learning phase and inferencing phase of the description feature extraction unit 222b according to some embodiments of the present disclosure will be described with further reference to FIG. 7b. Here, <B1> of FIG. 7b shows the learning phase of the description feature extraction unit 222b, and <B2> of FIG. 7b shows the inferencing phase of the description feature extraction unit 222b.

Referring to FIGS. 2, 5, and 6, and <B1> of FIG. 7b, the description feature extraction unit 222b may be pre-trained by the training module 230 to output learning description features DF_learn based on the learning lecture data LD_learn and learning summarized data SD_learn when the learning lecture data LD_learn and the learning summarized data SD_learn are input. That is, the description feature extraction unit 222b may use the learning lecture data LD_learn, the learning summarized data SD_learn, and the learning description features DF_learn as a training data set in the learning phase.

The learning description features DF_learn may include learning description method information DF1_learn and learning description sequence information DF2_learn.

In this case, the learning summarized data SD_learn may be used in the learning process in which the description feature extraction unit 222b outputs the learning description sequence information DF2_learn. That is, the description feature extraction unit 222b may be trained to output the learning description method information DF1_learn based on the learning lecture data LD_learn when the learning lecture data LD_learn is input, and may be trained to output the learning description sequence information DF2_learn based on the learning lecture data LD_learn and the learning summarized data SD_learn when the learning lecture data LD_learn and the learning summarized data SD_learn are input. In this case, the description feature extraction unit 222b may be trained to compare the learning lecture data LD_learn with the learning summarized data SD_learn generated by the lecture summarization unit 221 in the learning process, and output the learning description sequence information DF2_learn based on the comparison result, as described above.

In one or more embodiments, the aforementioned comparison process is a technological innovation that enables computers to infer the pedagogical structure of a lecture without manual labeling. By aligning AI-generated summaries with raw content timelines, the system enhances the ability of computing devices to identify instructional flow and topic organization—thereby improving the utility of educational indexing systems.

These learning description features DF_learn may be data input by the manager of the lecture analysis device 200. In other words, the learning description features DF_learn may be data input by the manager of the lecture analysis device 200 so as to match the lecture data LD_learn as learning data. In this case, the learning description method information DF1_learn and the learning description sequence information DF2_learn may be input to the description feature extraction unit 222b as the results of the respective category classification (e.g., in the case of the learning description method information DF1_learn, one of the storytelling method, exemplification method, and visual materialization method), as described above.

In this case, the learning description features DF_learn may be used as correct answer data, i.e., labeling data. In other words, in the learning phase of the description feature extraction unit 222b, the learning description method information DF1_learn and learning description sequence information DF2_learn input by the manager of the lecture analysis device 200 may be used as labeling data.

That is, the description feature extraction unit 222b may be trained in a supervised learning manner in which the learning lecture data LD_learn is input to the input terminal and the learning description features DF_learn are applied to the output terminal. However, this is merely one example and the present disclosure is not limited thereto.

Referring to FIGS. 2, 5, and 6, and <B2> of FIG. 7b, when the lecture data LD_inference is input as input data in the inferencing phase, the description feature extraction unit 222b may output description features DF_inference corresponding to the lecture data LD_inference. In this case, the description features DF_inference may include description method information DF1_inference and description sequence information DF2_inference, as described above.

The entertainment feature extraction unit 222c may extract the entertainment features (hereinafter referred to as “EF”) of the teacher in the corresponding online lecture based on the lecture data LD. In this case, the entertainment features EF may refer to features related to the level of entertainment of the teacher in the corresponding online lecture. In this case, the entertainment feature extraction unit 222c may extract the entertainment features EF based on the audio data LD2 included in the lecture data LD. In this case, the audio data LD2 may include both the voice of the teacher and the voices of the students in the online lecture, as described above.

As one example, the entertainment features EF may include data related to the voice uttered by the teacher outside the lecture content in the online lecture, i.e., jokes, and information on the communication with the students according thereto. In other words, the entertainment feature extraction unit 222c may extract the joke information of the teacher and the reaction information on the reactions by the students to the jokes as the entertainment features EF.

The joke information may include data on the type and duration of the joke spoken by the teacher in the online lecture. As one example, the joke information may include the degree of relevance of the jokes of the teacher to the lecture content, the proportion of time the teacher joked that takes up in the total lecture time, etc.

The reaction information may include data on the degree to which the students reacted to the jokes of the corresponding teacher. As one example, the reaction information may include the laughter decibel magnitude, the duration of laughter, the total amount of laughter decibels in the corresponding online lecture, etc., of the students.

In one or more embodiments, the system further addresses a technical problem in the analysis of instructional content by comparing raw lecture data with AI-generated summaries to infer the presentation sequence used by the instructor. This allows the system to determine whether a lecture follows a predefined order, such as a textbook structure, or a more personalized delivery approach. This capability enables computers to detect instructional organization and sequencing without requiring pre-tagged transcripts or manual input, thereby improving the ability of computing systems to interpret, classify, and index educational content for recommendation, retrieval, or personalization purposes.

In the following, the learning phase and inferencing phase of the entertainment feature extraction unit 222c according to some embodiments of the present disclosure will be described with further reference to FIG. 7c. Here, <C1> of FIG. 7c shows the learning phase of the entertainment feature extraction unit 222c, and <C2> of FIG. 7c shows the inferencing phase of the entertainment feature extraction unit 222c.

Referring to FIGS. 2, 5, and 6, and <C1> of FIG. 7c, the entertainment feature extraction unit 222c may be pre-trained by the training module 230 to output learning entertainment features EF_learn based on the learning lecture data LD_learn when the learning lecture data LD_learn is input. That is, the entertainment feature extraction unit 222c may use the learning lecture data LD_learn and the learning entertainment features EF_learn as a training data set in the learning phase.

The learning entertainment features EF_learn may include learning joke information EF1_learn and learning reaction information EF2_learn.

The learning entertainment features EF_learn may be data input by the manager of the lecture analysis device 200. In other words, the learning entertainment features EF_learn may be data input by the manager of the lecture analysis device 200 so as to match the lecture data LD_learn as learning data. In this case, the learning joke information EF1_learn may include the degree of relevance of the jokes of the teacher to the lecture content, the proportion of time the teacher joked that takes up in the total lecture time, etc., as described above, and the learning reaction information EF2_learn may include the laughter decibel magnitude, the duration of laughter, the total amount of laughter decibels in the corresponding online lecture, etc., of the students

In this case, the learning entertainment features EF_learn may be used as correct answer data, i.e., labeling data. In other words, in the learning phase of the entertainment feature extraction unit 222c, the learning joke information EF1_learn and the learning reaction information EF2_learn input by the manager of the lecture analysis device 200 may be used as labeling data.

That is, the entertainment feature extraction unit 222c may be trained in a supervised learning manner in which the learning lecture data LD_learn is input to the input terminal and the learning entertainment features EF_learn are applied to the output terminal. However, this is merely one example and the present disclosure is not limited thereto.

Referring to FIGS. 2, 5, and 6, and <C2> of FIG. 7c, when the lecture data LD_inference is input as input data in the inferencing phase, the entertainment feature extraction unit 222c may output entertainment features EF_inference corresponding to the lecture data LD_inference. In this case, the entertainment features EF_inference may include joke information EF1_inference and reaction information EF2_inference, as described above.

Finally, the teacher analysis unit 222 may determine and output at least one of the generated conversational features CF, description features DF, and entertainment features EF as the teacher analysis data TAD.

In addition, in one or more embodiments, the system enables computing devices to assess audience engagement by detecting spontaneous reactions, such as laughter or other audio responses, and correlating them with the instructor's delivery. This analysis uses time-aligned acoustic data and content features to model the relationship between entertainment attempts and actual student responses. By integrating this capability, the system improves over conventional multimedia analysis tools that cannot evaluate engagement levels or emotional responsiveness in real-world lecture environments.

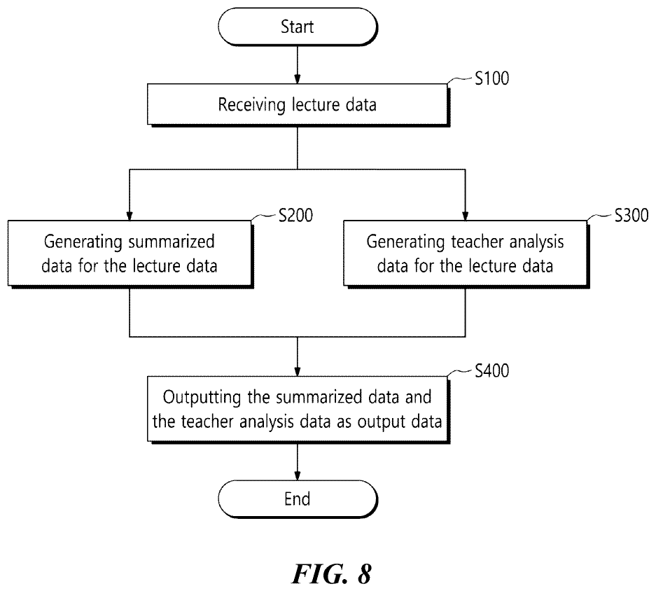

FIG. 8 is a flowchart of a lecture analysis method according to some embodiments of the present disclosure. Each step (S100 to S400) of FIG. 8 may be performed by the lecture analysis device 200 of FIGS. 1 and 2. In the following, descriptions will be made briefly with the overlapping parts excluded.

Referring to FIGS. 1, 2, 5, 6, and 8, the data collection module 210 may receive lecture data LD from the lecture database 100 (S100).

The lecture data LD may include lecture content in an online lecture. For example, the lecture data LD may include video data obtained by capturing an online lecture, audio data obtained by recording voices in the online lecture, etc., but the embodiment of the present disclosure is not limited thereto, and the lecture data LD may also include text data or image data for textbooks, lecture materials, etc., used in conducting the corresponding online lecture.

Next, the analysis module 220 may generate summarized data SD for the lecture data LD (S200), and may generate teacher analysis data TAD for the lecture data LD (S300).

As one example, the lecture summarization unit 221 may generate the summarized data SD based on the lecture data LD. The summarized data SD may be data obtained by summarizing the lecture content in the lecture data LD. As some examples, the lecture summarization unit 221 may generate the summarized data SD by inputting the lecture data LD into a pre-trained summarization model. In this case, the summarization model may be a model based on a transformer structure out of the types of neural networks. As one example, the summarization model may include a generative neural network model (e.g., ChatGPT) or a modified model thereof, but the embodiment of the present disclosure is not limited thereto. In this case, the summarization model may be pre-trained to generate the summarized data SD by extracting the main contents from the lecture data LD when the corresponding lecture data LD is input.

As another example, the teacher analysis unit 222 may generate the teacher analysis data TAD based on the lecture data LD. The teacher analysis data TAD may be data obtained by analyzing the features of the teacher in the lecture data LD. In this case, the lecture data LD may include the video data LD1 and the audio data LD2 as described above. As a first example, the conversational feature extraction unit 222a may extract the conversational features CF of the teacher in the corresponding online lecture based on the lecture data LD. In this case, the conversational features CF may refer to features related to the voice uttered by the teacher in the corresponding online lecture. In this case, the conversational feature extraction unit 222a may extract the conversational features CF based on the audio data LD2 included in the lecture data LD. As a second example, the description feature extraction unit 222b may extract the description features DF of the teacher in the corresponding online lecture based on the lecture data LD. In this case, the description features DF may refer to features related to the way the teacher delivers the lecture content while conducting the corresponding online lecture. In this case, the description feature extraction unit 222b may extract the description features DF based on the video data LD1 and the audio data LD2 included in the lecture data LD. As a third example, the entertainment feature extraction unit 222c may extract the entertainment features EF of the teacher in the corresponding online lecture based on the lecture data LD. In this case, the entertainment features EF may refer to features related to the level of entertainment of the teacher in the corresponding online lecture. In this case, the entertainment feature extraction unit 222c may extract the entertainment features EF based on the audio data LD2 included in the lecture data LD. In this case, the audio data LD2 may include both the voice of the teacher and the voices of the students in the online lecture, as described above.

Next, the output module 240 may output the summarized data SD and the teacher analysis data TAD as output data OD (S400).

As one example, the analysis data AD may include summarized data and teacher analysis data as described below, where the teacher analysis data may include conversational features (e.g., speaking mannerism, vocabulary, use of standard language, pronunciation accuracy, etc.), description features (e.g., description method information, description sequence information, etc.), and other entertainment features related to the entertainment in the class (e.g., the level of jokes shared in class and the degree of reaction thereto) of the teacher who conducted the corresponding online lecture, and in this case, the output module 240 may generate and output a graphic object in which the summarized data, the conversational features, description features, and entertainment features of the teacher, etc., are visually comprehensively displayed as the output data OD. In this case, the output data OD may be in the form of a text graphic object, an image graphic object, a video graphic object, etc.

Further, when the output data OD based on the analysis data AD is generated, the output module 240 may output the generated output data OD to a user terminal or the like linked to the lecture database 100 and the lecture analysis device 200. In this case, the user corresponding to the user terminal may refer to a student who is taking or intends to take the online lecture.

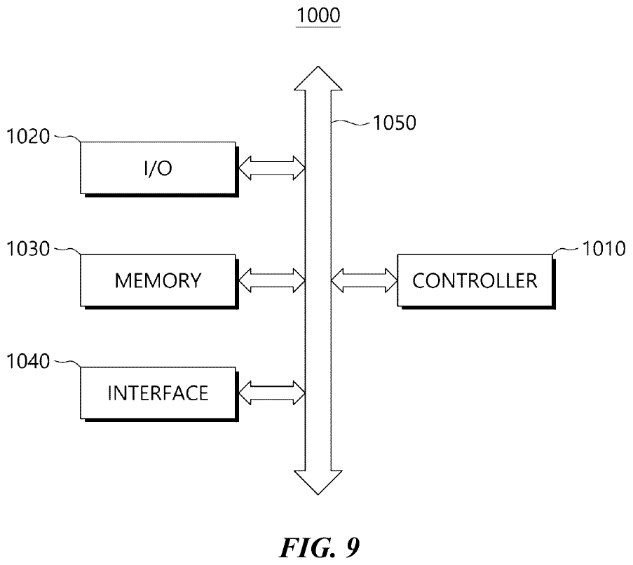

FIG. 9 is a diagram for describing a hardware implementation of a lecture analysis device that performs a lecture analysis method according to some embodiments of the present disclosure.

Referring to FIGS. 1 and 9, the lecture analysis device 200 according to some embodiments of the present disclosure may be implemented in an electronic device 1000. The electronic device 1000 may include a controller 1010, an input/output device I/O 1020, a memory device 1030, an interface 1040, and a bus 1050. The controller 1010, the input/output device 1020, the memory device 1030, and/or the interface 1040 may be coupled to each other via the bus 1050. In this case, the bus 1050 corresponds to a path through which data is moved.

Specifically, the controller 1010 may include at least one of a central processing unit (CPU), a microprocessor unit (MPU), a microcontroller unit (MCU), a graphic processing unit (GPU), a microprocessor, a digital signal processor, a microcontroller, an application processor (AP), and logic devices capable of performing functions similar thereto.

The input/output device 1020 may include at least one of a keypad, a keyboard, a touch screen, and a display device.

The memory device 1030 may store data and/or a program, etc.

The interface 1040 may perform the function of transmitting data to a communication network or receiving data from the communication network. The interface 1040 may be of a wired or wireless form. For example, the interface 1040 may include an antenna, a wired/wireless transceiver, or the like. Although not shown, the memory device 1030 may be an operating memory for improving the operation of the controller 1010, which may further include a high-speed DRAM and/or SRAM, etc. The memory device 1030 may store a program or an application therein.

The lecture analysis device 200 according to the embodiments of the present disclosure may be a system formed by connecting a plurality of electronic devices 1000 to each other via a network. In such a case, each module or combinations of modules may be implemented in the electronic device 1000. However, the present embodiment is not limited thereto.

Additionally, the lecture analysis device 200 may be implemented in at least one of a workstation, a data center, an Internet data center (IDC), a direct-attached storage (DAS) system, a storage area network (SAN) system, a network-attached storage (NAS) system, a redundant array of inexpensive disks or redundant array of independent disks (RAID) system, and an electronic document management system (EDMS), but the present embodiment is not limited thereto.

Furthermore, the lecture analysis device 200 may transmit data to the lecture database 100 via a network. The network may include a network based on wired Internet technology, wireless Internet technology, and short-range communication technology. The wired Internet technology may include, for example, at least one of a local area network (LAN) and a wide area network (WAN).

The wireless Internet technology may include, for example, at least one of wireless LAN (WLAN), Digital Living Network Alliance (DMNA), Wireless Broadband (WiBro), World Interoperability for Microwave Access (WiMAX), High Speed Downlink Packet Access (HSDPA), High Speed Uplink Packet Access (HSUPA), IEEE 802.16, Long Term Evolution (LTE), Long Term Evolution-Advanced (LTE-A), Wireless Mobile Broadband Service (WMBS), and 5G New Radio (NR) technology. However, the present embodiment is not limited thereto.

The short-range communication technology may include, for example, at least one of Bluetooth, Radio Frequency Identification (RFID), Infrared Data Association (IrDA), Ultra-Wideband (UWB), ZigBee, Near Field Communication (NFC), Ultra Sound Communication (USC), Visible Light Communication (VLC), Wi-Fi, Wi-Fi Direct, and 5G New Radio (NR). However, the present embodiment is not limited thereto.

The lecture analysis device 200 communicating over a network may comply with technical standards and standard communication methods for mobile communication. For example, the standard communication methods may include at least one of Global System for Mobile communication (GSM), Code Division Multiple Access (CDMA), Code Division Multiple Access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), Long Term Evolution-Advanced (LTE-A), and 5G New Radio (NR). However, the present embodiment is not limited thereto.

The disclosed system provides technical improvements in the field of computer-implemented content analysis by enabling automated generation of educational summaries and instructor behavioral profiles from unstructured audiovisual lecture data. In contrast to generic machine learning or content indexing systems, the present invention employs a modular architecture of pre-trained neural networks tailored for specific tasks, including lecture summarization, topic sequencing, conversational pattern extraction, and audience reaction detection. These components operate on synchronized multimodal inputs to generate structured analysis data. This architecture improves the functioning of computing systems by enabling accurate, scalable, and domain-specific analysis that conventional systems cannot achieve.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims. It is therefore desired that the embodiments be considered in all respects as illustrative and not restrictive, reference being made to the appended claims rather than the foregoing description to indicate the scope of the disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A lecture analysis device comprising:
a data collection module configured to receive lecture data including lecture content in an online lecture;
an analysis module configured to generate analysis data including at least one of summarized data for the online lecture and teacher analysis data related to a teacher who conducted the online lecture based on the received lecture data; and
an output module configured to output the analysis data as output data,
wherein the analysis module generates the analysis data from the lecture data based on a pre-trained neural network.

2. The lecture analysis device of claim 1, wherein the lecture data comprises:
video data obtained by capturing the online lecture; and
audio data for voices in the online lecture.

3. The lecture analysis device of claim 1, wherein the analysis module comprises:
a lecture summarization unit configured to generate the summarized data by summarizing the lecture content based on the lecture data; and
a teacher analysis unit configured to generate the teacher analysis data by analyzing features of a teacher who conducts the online lecture based on the lecture data.

4. The lecture analysis device of claim 3, wherein the teacher analysis unit comprises:
a conversational feature extraction unit configured to extract conversational features related to a voice of the teacher based on the lecture data;
a description feature extraction unit configured to extract description features related to a delivery method of the lecture content of the teacher based on the lecture data; and
an entertainment feature extraction unit configured to extract entertainment features related to a level of entertainment of the teacher based on the lecture data.

5. The lecture analysis device of claim 4, wherein the conversational feature extraction unit extracts at least one of speaking mannerism information related to a speaking mannerism of the teacher, vocabulary information related to vocabulary related to words used by the teacher, standard language information related to whether the teacher speaks a standard language, and pronunciation information related to pronunciation accuracy of the teacher, as the conversational features.

6. The lecture analysis device of claim 4, wherein the description feature extraction unit extracts at least one of description method information and description sequence information of the teacher as the description features.

7. The lecture analysis device of claim 6, wherein the description feature extraction unit extracts at least one of a storytelling method, an exemplification method, and a visual materialization method as the description method information.

8. The lecture analysis device of claim 6, wherein the description feature extraction unit:
receives the summarized data from the lecture summarization unit,
compares the summarized data with the lecture data, and
based on a comparison result, extracts a sequence of mention for each of a plurality of topics included in the lecture content as the description sequence information.

9. The lecture analysis device of claim 4, wherein the entertainment feature extraction unit extracts at least one of joke information related to a level of jokes in the online lecture by the teacher and reaction information related to reactions by students to the jokes as the entertainment features.

10. The lecture analysis device of claim 4, further comprising:
a training module configured to train the conversational feature extraction unit, the description feature extraction unit, and the entertainment feature extraction unit included in the teacher analysis unit, and the lecture summarization unit.
